(19) United States
(12) Patent Application Publication
(10) Pub. No.: US 2012/0111797 A1
(43) Pub. Date: May 10, 2012

(54) RENEWABLE OIL ABSORBENT AND METHOD THEREOF

(75) Inventor: M. Carl LAVOIE, Senneterre (CA)

(73) Assignee: Carl Lavoie, Senneterre (CA)

(21) Appl. No.: 13/283,937

(22) Filed: Oct. 28, 2011

Related U.S. Application Data
(60) Provisional application No. 61/411,533, filed on Nov. 9, 2010.

(51) Int. Cl. C02F 1/40; A24D 3/10; B01J 20/22; B01J 20/281; B01D 39/02; B01D 15/00

(52) U.S. Cl. 210/690; 210/502.1; 428/221; 442/1; 210/242.4; 502/401; 131/331

(57) ABSTRACT

The present document describes an oil absorbent fiber comprising fragments of typha plant inflorescence, absorption apparatus comprising the oil absorbent fibers, as well as method of using the absorbent and/or the apparatus for absorbing oil.

### CROSS-REFERENCE TO RELATED APPLICATIONS

This application claims priority under 35USC§119(e) of U.S. provisional patent application 61/411,533, filed on Nov. 9, 2010, the specification of which is hereby incorporated by reference.

### BACKGROUND

(a) Field

The subject matter disclosed generally relates to an oil absorbent fiber, apparatus for absorbing oil and method of using the same. More specifically, the subject matter disclosed relates to oil absorbent fibers and apparatus for absorbing oil comprising fragments of typha plant inflorescence, and method of using them.

(b) Related Prior Art

Oil spills are extremely inconvenient accidents that range from the simple household spill of oil in the garage or kitchen, to the environmental disasters having a profound impact on the environment in which they occur, causing almost irreversible damages the animal and plant fauna.

Absorption of the spilled oil material is a decontamination strategy that allow in part for the cleaning of environments subjected to oils spills. International patent publication No. WO921726A1 (Lohr) describes hydrophobic cellulosic material containing waxed cardboard that can be used for absorbing oil wastes and spills in garage and plants. However, Lohr uses waxed cardboards as a primary source of absorbing material. Waxed carboard is industrially produced and requires a large amount of cellulosic material from trees, as well as wax in order to be prepared.

Therefore, there is a need for an absorbing material of natural origin.

There is a need for an absorbing material of natural origin that would display similar hydrophobic properties as this of waxed cardboard.

### SUMMARY

According to an embodiment, there is provided an oil absorbent fiber comprising fragments of typha plant inflorescence.

The oil absorbent fiber may be waterproof.

The typha plant inflorescence may be the female part of typha plant inflorescence.

The typha plant inflorescence may be from typha latifolia, typha angustifolia, typha domingensis, typha xglauca, typha laxmannii, typha minima, typha muelleri, typha orientalis, typha capensis, typha shuttleworthii, or combinations thereof.

The typha plant inflorescence may be sterilized.

According to another embodiment, there is provided a pellet comprising an oil absorbent fiber according to the present.

According to another embodiment, there is provided a thread comprising an oil absorbent fiber according to the present invention.

According to another embodiment, there is provided a fabric comprising a thread according to the present invention.

According to another embodiment, there is provided a web comprising a thread according to the present invention.

According to another embodiment, there is provided a net comprising a thread according to the present invention.

According to another embodiment, there is provided a fabric comprising an oil absorbent fiber according to the present invention.

According to another embodiment, there is provided a web comprising an oil absorbent fiber according to the present invention.

According to another embodiment, there is provided a net comprising an oil absorbent fiber according to the present invention.

According to another embodiment, there is provided a clothing article comprising a fabric according to the present invention.

The clothing article may be a glove.

According to another embodiment, there is provided a clothing article insulation material comprising an oil absorbent fiber according to the present invention.

According to another embodiment, there is provided a footwear article comprising a fabric according to the present invention.

According to another embodiment, there is provided a cigarette filter comprising an oil absorbent fiber according to the present invention.

According to another embodiment, there is provided a filter comprising an oil absorbent fiber according to the present invention.

According to another embodiment, there is provided an apparatus for the absorption of oil comprising a oil absorbent fiber according to the present invention; and a support to secure said oil absorbent fiber.

The support may be in the shape of a sheet, a web, a net, a roller, a tube, a bead, and a ball.

The oil absorbent fiber may be secured inside said support.

The support may comprise apertures or pores through which said oil is capable of entering said support.

The oil absorbent fiber may be secured at the surface of said support.

The support may be a binding agent.

The binding agent may be an adhesive binding said oil absorbent fiber together.

The apparatus may be floatable.

According to another embodiment, there is provided a method of absorbing oil comprising contacting the oil with an oil absorbent fiber according the present invention for a time sufficient for the oil to be absorbed by the oil absorbent.

The method may further comprise the step of removing the oil absorbent fiber with absorbed oil.

The oil may be in suspension in an aqueous media.

The oil may be collected from the oil absorbent fiber.

The oil absorbent may be reused to absorbed oil.

According to another embodiment, there is provided a method of absorbing oil comprising contacting the oil with an apparatus for the absorption of oil according to the present invention for a time sufficient for the oil to be absorbed by the apparatus.

The method may further comprise the step of removing the oil absorbent with absorbed oil.

The oil may be in suspension in an aqueous media.

The oil may be collected from said oil absorbent.

The oil absorbent may be reused to absorbed oil.

According to another embodiment, there is provided an oil spill cleaning kit comprising at least one oil absorption apparatus according to the present invention, and instructions to use the kit.

According to an embodiment, there is provided an oil absorbent fiber comprising fragments of typha plant inflorescence.

The oil absorbent may be waterproof.

The typha plant inflorescence may be the female part of typha plant inflorescence.

The typha plant inflorescence may be from typha latifolia, typha angustifolia, typha domingensis, typha xglauca, typha laxmannii, typha minima, typha muelleri, typha orientalis, typha capensis, typha shuttleworthii, or combinations thereof.

According to another embodiment, there is provided an article comprising an oil absorbent fiber according to the present invention.

The article may be chosen from a fabric, a web, a net, a cigarette filter, a filter, a pellet, and a thread.

According to another embodiment, there is provided a clothing article comprising a fabric according to the present invention.

According to another embodiment, there is provided an apparatus for the absorption of oil comprising:
a oil absorbent fiber according to the present invention; and
a support to secure the oil absorbent fiber.

The oil absorbent fiber may be secured inside the support.

The support may comprise apertures or pores through which the oil is capable of entering the support.

The support may comprise a binding agent.

The binding agent may be an adhesive binding the oil absorbent fiber together.

The apparatus may be floatable.

According to another embodiment, there is provided a method of absorbing oil comprising:

contacting the oil with an oil absorbent fiber according to the present invention, for a time sufficient for the oil to be absorbed by the oil absorbent.

According to an embodiment, there is provided a method of absorbing oil comprising:
contacting the oil with an apparatus for the absorption of oil according to the present invention, for a time sufficient for the oil to be absorbed by the apparatus.

The following terms are defined below.

The term “oil” is intended to mean any substance that is liquid at ambient temperatures and is hydrophobic but soluble in organic solvents. Oils have a high carbon and hydrogen content and are nonpolar substances. The general definition above includes compound classes with, and uses, including vegetable oils, petrochemical oils (e.g. gasoline, diesel), crude oils, volatile essential oils, organic oils, mineral oils, and synthetic oils.

The term “aqueous media” is intended to mean a media in which the solvent is water. The word aqueous means pertaining to, related to, similar to, or dissolved in water. Substances which are hydrophobic (‘water fearing’) often do not dissolve well in water whereas those that hydrophilic (‘water-loving’) do. An example of a hydrophilic substance would be sodium chloride (ordinary table salt. Acids and bases are aqueous solutions, as part of their Arrhenius definitions. The ability of a substance to dissolve in water is determined by whether the substance can match or exceed the strong attractive forces that water molecules generate between themselves. If the substance lacks the ability to dissolve in water the molecules form a precipitate and be in suspension. Aqueous media that conduct electric current efficiently contain strong electrolytes, while ones that conduct poorly are considered to have weak electrolytes. Those strong electrolytes are substances that are completely ionized in water, whereas the weak electrolytes exhibit only a small degree of ionization in water. Nonelectrolytes are substances that dissolve in water, but which maintain their molecular integrity (do not dissociate into ions). Examples include sugar, urea, glycerol, and methylsulfonylmethane (MSM).

The term “fragment” is intended to mean any small or large piece broken off or cut off, torn, removed of the inflorescence. The fragment of plant inflorescence may range from rough, chunky pieces of inflorescence, and the soft fibrous material resulting teasing apart the inflorescence. Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates the inflorescence of members of the typha latifolia species.

FIG. 2A illustrates a top view of an apparatus for absorption of oil according to an embodiment of the present invention.

FIG. 2B illustrates a side view of an apparatus for absorption of oil according to an embodiment of the present invention.

FIG. 3 illustrates an apparatus for absorption of oil according to an embodiment of the present invention.

FIG. 4A illustrates an apparatus for absorption of oil according to an embodiment of the present invention.

FIG. 4B illustrates an apparatus for absorption of oil according to an embodiment of the present invention.

FIG. 4C illustrates an apparatus for absorption of oil according to an embodiment of the present invention.

It will be noted that throughout the appended drawings, like features are identified by like reference numerals.

### DETAILED DESCRIPTION OF THE PREFERRED EMBODIMENTS

In embodiments there is disclosed an oil absorbent fiber made from the inflorescence of a Typha plant. Typha is a genus of about eleven species of monocotyledonous flowering plants in the monogeneric family Typhaceae. The genus has a largely Northern Hemisphere distribution, but is essentially cosmopolitan, being found in a variety of wetland habitats. These plants are known in British English as bulrush, bullrush, or reedmace, in American English as cattail, punks, or corndog grass, and in New Zealand as raupo.

Typha plants are monoecious and bear unisexual, wind-pollinated flowers, developing in dense spikes. The numerous male flowers form a narrow spike at the top of the vertical stem. Each male (staminate) flower is reduced to a pair of stamens and hairs, and withers once the pollen is shed. The very large numbers of tiny female flowers form a dense, sausage-shaped spike on the stem below the male spike—in larger species this can be up to 30 centimetres (12 in) long and 1 to 4 centimetres (0.39 to 1.6 in) thick. Seeds are minute, 0.2 millimetres (0.0079 in) long, and attached to a fine hair. When ripe the heads disintegrate into dense cottony fluff, from which the seeds disperse by wind. Typha is often among the first wetland plants to colonize areas of newly exposed wet mud; it also spreads by rhizomes, forming dense stands often to the exclusion of other plants.

In accordance with the present invention the flower (inflorescence) part of Typha plants is particularly efficient at binding oil. The Typha plant inflorescence may be used in its entirety, however, the preferred portion of the plant is the female part of typha plant inflorescence. When collecting Typha plants for the preparation of oil absorbent, the dense, sausage-shaped spike of the female inflorescence may be preferably collected and the male spike left on the ground to ensure that the Typha plant will grow back and replenish the source of material, and providing a renewable source of primary material from which to prepare the absorbent of the present invention. The oil absorbent fiber may be prepared by reducing the Typha plant inflorescence in pieces by any suitable method (e.g. chopping, cutting, slicing, tearing, shredding, etc) to separate the inflorescence into the underlying fibrous material.

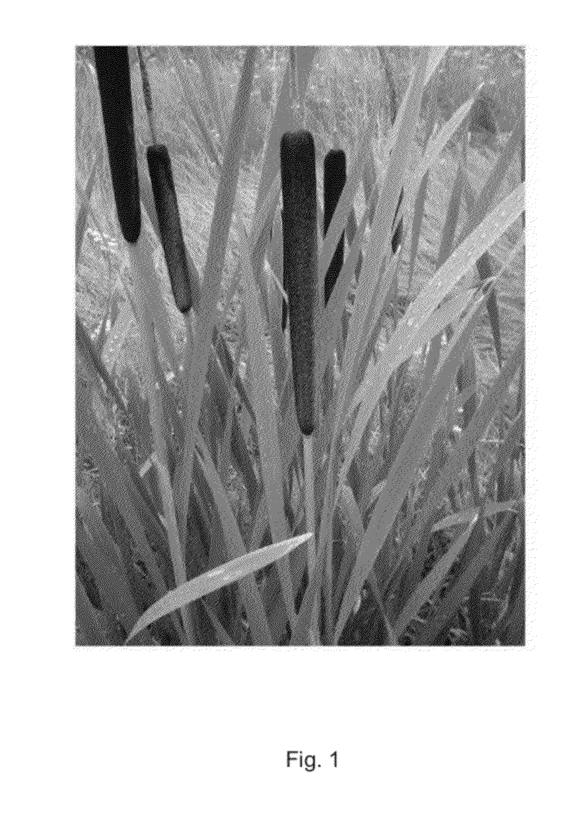

The inflorescence from any known member of the Typha genus may be used to manufacture the oil absorbent fiber of the present invention. These include but are not limited to typha latifolia (see FIG. 1), typha angustifolia, typha domingensis, typha xglauca, typha laxmannii, typha minima, typha muelleri, typha orientalis, typha capensis, typha shuttleworthii, or combinations thereof.

The oil absorbent fiber of the present invention may be Typha plant inflorescence used in a loose form, or granular pellets containing the material may be prepared from the loose form of the Typha inflorescence.

To facilitate long term storage, the oil absorbent fiber from Typha plant inflorescence may be bagged. To prevent the natural fibers of the inflorescence from degrading over time, the oil absorbent fiber from typha plant inflorescence is sterilized by autoclaving, UV treatment or any other suitable method of sterilization that will remove unwanted microorganisms while keeping the oil absorbent fiber intact for their absorbent purpose.

The oil absorbent fiber of the present invention may be formed into a thread, alone or in combination with other known fiber of natural origine (e.g. cotton, hemp, wool, silk, etc.) or synthetic origin (polyesters, nylons, Gore-tex™, rayon, viscose, and the like). The thread may be used for making fabrics, webs, and nets (or nettings).

According to another embodiment of the present invention, fabrics, webs, and nets (or nettings) may also be prepared by other methods than the known weaving of threads. The fabrics, webs, and nets (or nettings) are prepared with the oil absorbent fiber of the present invention.

The threads and fabrics may be used for the making of clothing articles such as pants, jackets, hats, gloves, shirts, etc, and footwear which comprise a fabric prepared from the thread or fabric of the present invention. The oil absorbent fiber may also be used for making clothing article insulation material, which may be the lining of the interior of warm jackets suitable for any season, as well as the actual insulation material found between the lining and the outer shell of such clothing.

The oil absorbent fiber of the present invention may be used also for the making of cigarette filters, which would efficiently bind oily residues present in the cigarette tobacco. The cigarette filter may be prepared to fit any type of cigarette. The cigarette filter may incorporate varying amount of oil absorbent fiber according to the present invention. The filter may be made entirely from oil absorbent fiber according to the present invention, or it may incorporate a percentage of oil absorbent fiber, and other suitable material that are well known to be used in the making of cigarette filters.

According to another embodiment of the present invention, the oil absorbent fiber may be used for the fabrication of filters that may be used filtration systems, or on portable filtration systems. The filter may be prepared in suitable sizes and shapes (e.g. rectangular, square, or circular frames) from commonly used materials such as plastics or metals. The filtration systems may be air filtration systems (residential, industrial), water filtration systems such as residential filtration system, but also including municipal water treatment plants, as well as industrial water treatment plants (e.g. to treat water from oil sand extraction plants).

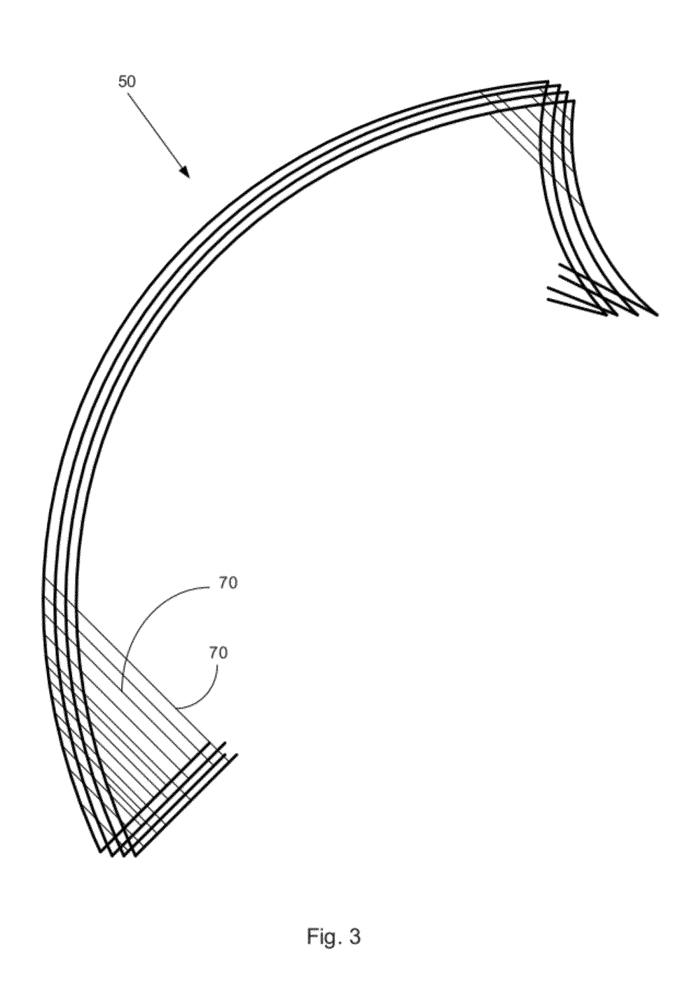

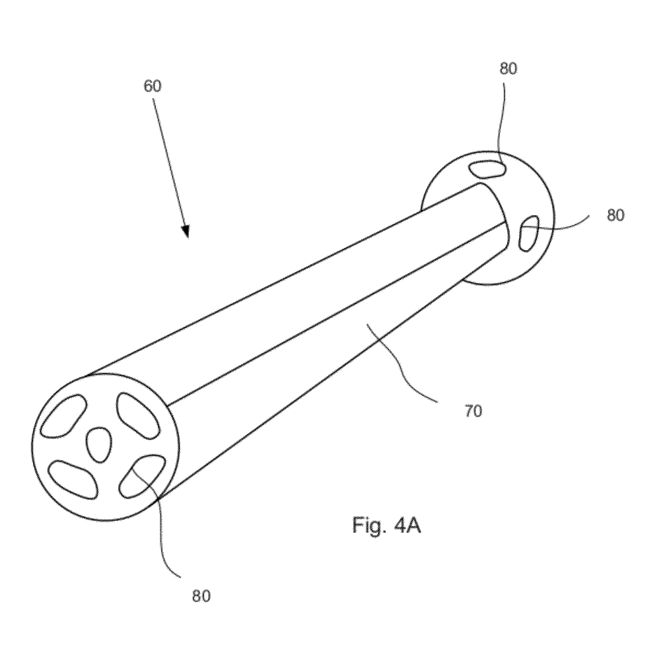

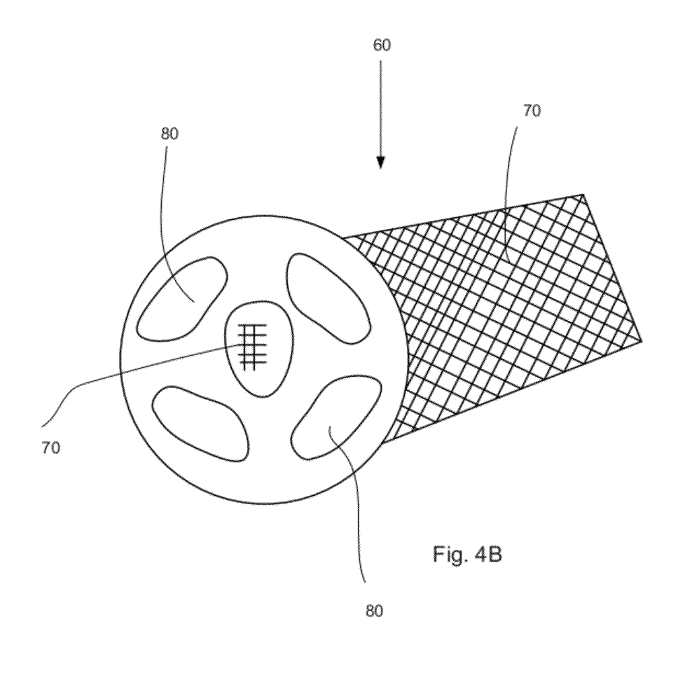

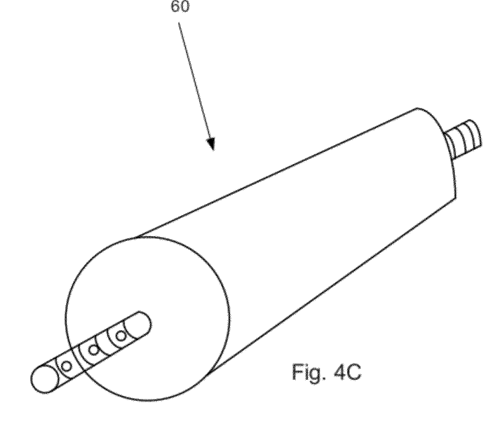

According to another embodiment of the present invention, there is disclosed an apparatus for the absorption of oil comprising the oil absorbent fiber and a support to secure said the oil absorbent fiber. The apparatus may be in any appropriate shape, such as a sheet, a web, a net, such as net 50 (see FIG. 3), a roller, such as roller 60 (see FIG. 4A, 4B or 4C), a tube, a bead, and a ball.

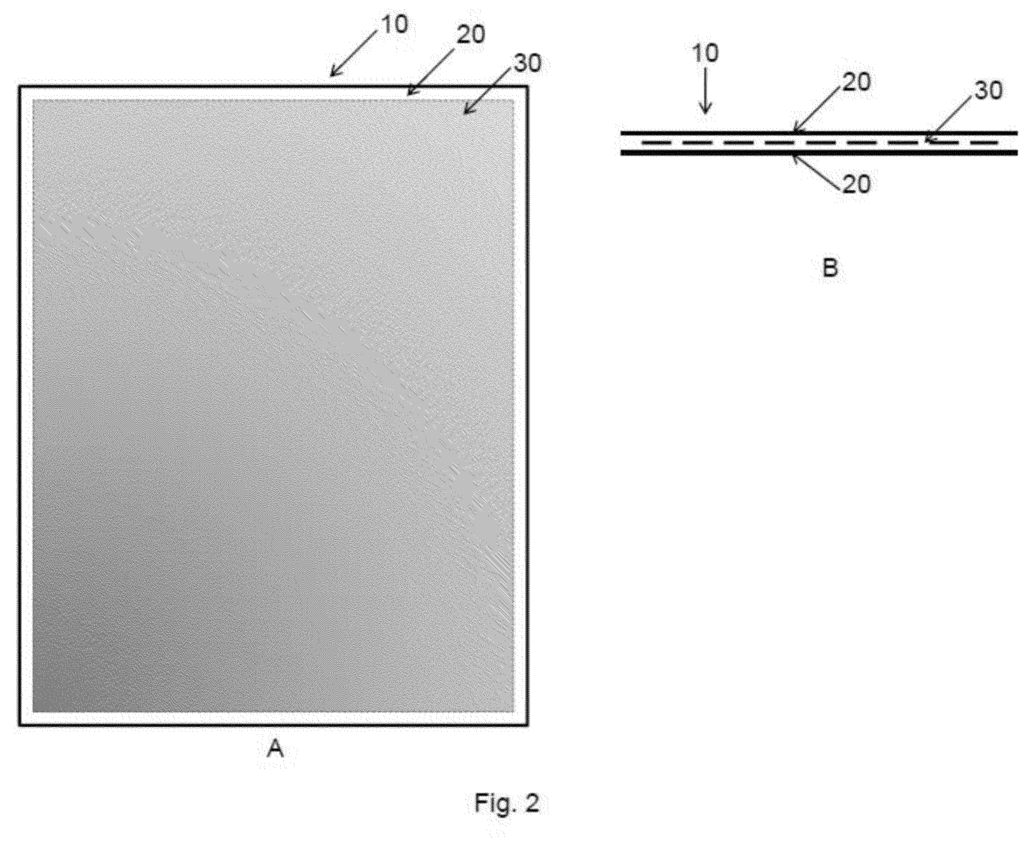

According to one embodiment, the oil absorbent fiber 70 is secured inside the support, and preferably, the support comprises openings, such as openings 80, apertures or pores through which the oil is capable of entering said support. For example, the support may be a sheet netting, such as those used for the fabrication of screen doors, inside of which the oil absorbent fiber 70 is placed. Now referring to FIGS. 2A and 2B showing an apparatus 10, comprised of netting sheets 20, and a layer 30 of oil absorbent fiber that is secured in between the two sheets 20. In use, the oil fluid may pass through the openings and be absorbed by the absorbent material.

According to another embodiment, the oil absorbent fiber 70 may be secured at the surface of a support, so that in use the apparatus, such as a roller 60, may be passed onto an oil stained surface, for example.

According to another embodiment, the apparatus support may be a binding agent such as an adhesive, that binding the oil absorbent fiber from Typha plant inflorescence together to form an apparatus that may be employed to absorb oil.

According to another embodiment of the present invention, the apparatus may be made floatable. Such apparatus may be used as a retention and absorption buoy where oil spills have occurred in water.

According to another embodiment of the present invention, there is disclosed a method of absorbing oil by contacting oil with an oil absorbent fiber according to an embodiment of the present invention, for a time sufficient for the oil to be absorbed by the oil absorbent. For example, the oil may be on a solid or semi-solid surface, or in may be in suspension in an aqueous media. The oil absorbent fiber may be placed directly on the surface of the oil spill, or even be used to absorb oil in suspension in an aqueous media (e.g. in water), as the absorbent is impermeable to water. Therefore, the absorbent could be used to capture crude oil spilling from offshore drilling platforms, or similar spills, if used in sufficiently large quantities or in embodiments that allow capture of the oil, its reabsorption and the reuse of the preferred embodiments (e.g. as floatable apparatus). The quantity of oil absorbed by the oil absorbent fiber of the present invention will vary according to the oil being absorbed. After the oil has been absorbed on the oil absorbent fiber, the oil and absorbent aggregate may be removed.

According to an embodiment of the present invention, the oil can be collected from the oil absorbent fiber and reused for its initial purpose. The aggregate of oil and oil absorbent fiber is sufficiently coherent to be collected and kept for later extracting the oil material therefrom, if desired. Thus, this method could be used as a means for separating oil or oil residues from water or other aqueous solvent. The oil absorbent may be discarded, or reused to absorb more oil.

According to another embodiment of the present invention, there is disclosed a method of absorbing oil by contacting the oil with an apparatus for the absorption of oil according to the present invention, for a time sufficient for the oil to be absorbed by said apparatus. For example, the oil may be on a solid or semi-solid surface, or in may be in suspension in an aqueous media. The apparatus may be placed directly on the surface of the oil spill, or even be used to absorb oil in suspension in an aqueous media (e.g. in water), as the absorbent therein is impermeable to water. Therefore, the absorbent could be used to capture crude oil spilling from offshore drilling platforms, or similar spills, if used in sufficiently large quantities or in embodiments that allow capture of the oil, its reabsorption and the reuse of the preferred embodiments (e.g. as floatable apparatus). The quantity of oil absorbed by the absorbent of the present invention will vary according to the oil being absorbed. After the oil has been absorbed on the apparatus, the oil and apparatus aggregate may be removed.

According to an embodiment of the present invention, the oil can be collected from the apparatus for absorption of oil and reused for its initial purpose. The aggregate of oil and the apparatus for the absorption of oil is sufficiently coherent to be collected and kept for later extracting the oil material therefrom, if desired. Thus, this method could be used as a means for separating oil or oil residues from water or other aqueous solvent.

Separation may be effected by compressing the aggregate of oil and the absorbent or the apparatus such that the oil is ejected from the aggregate. The apparatus for absorption of oil may be discarded, or reused to absorb more oil.

The present invention will be more readily understood by referring to the following examples which are given to illustrate the invention rather than to limit its scope.

### Example 1

### Absorption of Heavy Duty Engine Oil from Water

2 L of Rotella® TSB SAE OE-30 heavy duty engine oil (Shell™) are poured in 10 L water and shredded 217 g of Typha latifolia female inflorescence are overlaid the oil. The solution is stirred and the oil and oil absorbent fiber coalesce into a mass floating over the water. The aggregate is lifted from the water and put aside.

### Example 2

### Absorption of Engine Oil from Water

25 ml of Ultramar™ 5W-30 engine oil are poured in 1 L of water and shredded 2.7 g of Typha latifolia female inflorescence formed in the shape of a ball are inserted in the oil and water mixture. The mixture is stirred and the oil is absorbed on the oil absorbent fiber ball in its entirety. The aggregate is lifted from the water and put aside.

### Example 3

### Absorption of Automobile Transmission Oil from Water

25 ml of ultralube ATF (Ultramar™) oil are poured in 1 L water and shredded 2.7 g of Typha latifolia female inflorescence formed in the shape of a ball are inserted in the oil and water mixture. The mixture is stirred and the oil is absorbed on the shredded fiber ball in its entirety. The aggregate is lifted from the water and put aside.

### Example 4

### Absorption of Heavy Duty Engine Oil from Water

250 ml of Rotella® TSB SAE OE-30 heavy duty engine oil (Shell™) are poured in water and shredded 27 g of Typha latifolia female inflorescence inserted in between two sheets of screen door material sealed at the outside are soaked in the oil and water mixture. The apparatus is soaked on one side, and then turned on the other side to ensure complete absorption of the oil by the shredded fiber ball in its entirety. The aggregate is lifted from the water and put aside.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An oil absorbent fiber comprising fragments of typha plant inflorescence.

2. The oil absorbent fiber of claim 1, wherein said oil absorbent fiber is waterproof.

3. The oil absorbent fiber of claim 1, wherein said typha plant inflorescence is the female part of typha plant inflorescence.

4. The oil absorbent fiber of claim 1, wherein said typha plant inflorescence is from typha latifolia, typha angustifolia, typha domingensis, typha xglauca, typha laxmannii, typha minima, typha muelleri, typha orientalis, typha capensis, typha shuttleworthii, or combinations thereof.

5. An article comprising an oil absorbent fiber according to claim 1.

6. The article of claim 5, wherein said article is chosen from a fabric, a web, a net, a cigarette filter, a filter, a pellet, and a thread.

7. A clothing article comprising a fabric according to claim 6.

8. An apparatus for the absorption of oil comprising:
a oil absorbent fiber according to claim 1; and
a support to secure said oil absorbent fiber.

9. The apparatus of claim 8, wherein said oil absorbent fiber is secured inside said support.

10. The apparatus of claim 8, wherein said support comprises apertures or pores through which said oil is capable of entering said support.

11. The apparatus of claim 10, wherein said support comprises a binding agent.

12. The apparatus of claim 11, wherein said binding agent is an adhesive binding said oil absorbent fiber together.

13. The apparatus according to claim 8, wherein said apparatus is floatable.

14. A method of absorbing oil comprising:
contacting said oil with an oil absorbent fiber according to claim 1, for a time sufficient for the oil to be absorbed by said oil absorbent.

15. A method of absorbing oil comprising:
contacting said oil with an apparatus for the absorption of oil according to claim 8, for a time sufficient for the oil to be absorbed by said apparatus.
